(19) United States
(12) Patent Application Publication
(10) Pub. No.: US 2014/0116385 A1
(43) Pub. Date: May 1, 2014

(54) DEVICE AND METHOD FOR DETERMINING AND CONTROLLING COMBUSTION MISFIRE OF VEHICLE ENGINE

(71) Applicant: Hyundai Motor Company, Seoul (KR)

(72) Inventors: Minsu KIM, Bucheon-si (KR); Jun YU, Suwon-si (KR); Hyungmin KIM, Ansan-si (KR); Kyoungchan HAN, Hwaseong-si (KR)

(73) Assignee: HYUNDAI MOTOR COMPANY, Seoul (KR)

(21) Appl. No.: 14/055,018

(22) Filed: Oct. 16, 2013

(30) Foreign Application Priority Data
Oct. 30, 2012 (KR) 10-2012-0121391

(51) Int. Cl. F02D 41/32

(52) U.S. Cl. CPC F02D 41/32
USPC 123/435

(57) ABSTRACT

A method of determining and controlling misfire in an engine. The method and device sense combustion pressure in a combustion chamber of an engine while the engine is operated; calculate MFB (a ratio of the amount of combustion heat at a specific point of time to the total amount of combustion heat), MFB50 (a point of time at which the amount of combustion heat is 50% of the total amount of combustion heat), MFB50 COV (Coefficient of Variation), IMEP (Indicated Mean Effective Pressure) and IMEP COV, from the combustion chamber; set a desired MFB50; and determine that there is misfire when a crank angle is delayed at 5 degrees or more, the MFB50 COV is 20% or more, or the IMEP COV is 20% or more, by comparing the calculated MFB50 with the desired MFB50; and then advance an injection time such that the MFB follows the desired MFB.

### CROSS-REFERENCE TO RELATED APPLICATION

This application claims priority to and the benefit of Korean Patent Application No. 10-201 2-01 21 391 filed in the Korean Intellectual Property Office on Oct. 30, 2012, the entire contents of which are incorporated herein by reference.

### BACKGROUND OF THE DISCLOSURE

(a) Field of the Disclosure

The present disclosure relates to a method of determining and controlling combustion misfire of an engine (e.g., of a vehicle), and a control device thereof. More particularly, the present disclosure relates to a method of determining and controlling combustion misfire of a vehicle engine which determines misfire by sensing combustion pressure of the engine and controls misfire by advancing a fuel injection time, and a control device thereof.

(b) Description of the Related Art

In general, in a vehicle engine, misfire is generated without normal combustion in the cylinders of the engine due to an ignition failure, a defect in a fuel supply system, a pressure decrease of fuel, or other reasons.

Misfire during combustion in an engine causes a loss of power from the engine and a non-uniform engine torque, such that a vibration or noise is generated from the engine.

The misfire in an engine means all processes where a flame is not propagated around an ignition source even though an igniter ignites a mixture of fuel and air mixed in a combustion chamber in an engine, where a flame is only partially propagated even if there is a propagation of flame, or where the propagation speed of a flame is irregular or an abnormal combustion is generated by speed delay Misfire contaminates the environment by increasing noxious gases that are exhausted, in addition to damaging the engine and the exhaustion system for exhaustion gases, depending on the state of the misfire.

Therefore, engine control that suppresses generation of misfire by detecting misfire in real time is very important in terms of improving the performance of a vehicle and reducing exhaustion gases.

The above information disclosed in this Background section is only for enhancement of understanding of the background of the disclosure and therefore it may contain information that is not prior art to the present disclosure.

### SUMMARY OF THE DISCLOSURE

The present disclosure has been made in an effort to provide a method and a control device having advantages of being able to accurately determine misfire, which may be generated in the combustion chamber of an engine, in real time by sensing combustion pressure, and to control misfire by advancing a fuel injection time.

An exemplary embodiment of the present disclosure provides a method of determining misfire in an engine, which may include: sensing combustion pressure in a combustion chamber of an engine while the engine is operated; calculating MFB (a ratio of the amount of combustion heat at a specific point of time to the total amount of combustion heat), MFB50 (a point of time at which the amount of combustion heat is 50% of the total amount of combustion heat), MFB50 COV (Coefficient of Variation), IMEP (Indicated Mean Effective Pressure) and IMEP COV, from the combustion chamber; setting a desired MFB50; and determining that there is misfire when a crank angle is delayed at 5 degrees or more, the MFB50 COV is 20% or more, or the IMEP COV is 20% or more, by comparing the calculated MFB50 with the desired MFB50.

The desired MFB50 may be set in accordance with the number of revolutions of an engine and engine load.

Another exemplary embodiment of the present disclosure provides a method of controlling misfire in an engine by advancing an injection time such that the MFB50 follows the desired MFB50, when it is determined that misfire has been generated in the process of combustion of fuel in the engine.

Whether a predetermined time has passed after the injection time is advanced may be determined, and a warning lamp may be turned on when misfire keeps progressing even after the predetermined time passes.

The predetermined time may be five seconds or more.

Yet another exemplary embodiment of the present disclosure provides a device for controlling misfire in an engine, which may include: a combustion pressure detecting sensor that senses combustion pressure in an engine; an injector that injects fuel into the engine; and a control unit that controls the injector by performing the method of controlling misfire.

The device may further include a warning lamp, and determine whether a predetermined time has passed, after the injection time is advanced, and turn on the warning lamp when the misfire keeps progressing even after the predetermined time passes.

The predetermined time may be five seconds or more.

According to an exemplary embodiment of the present disclosure, since misfire in a combustion chamber is determined by sensing combustion pressure, it is possible to accurately determine whether there is misfire in real time.

Further, since misfire is controlled by advancing the injection time of fuel when it is determined that misfire has been generated in the process of combustion in the engine, and the driver's attention is aroused by turning on the warning lamp when the misfire keeps progressing even under the control, it is possible to prevent a deterioration of stability of operating a vehicle and of riding comfort due to misfire generated in the engine, and to preclude a discharge of a large amount of noxious exhaustion gas and a reduction in fuel efficiency.

### BRIEF DESCRIPTION OF THE DRAWINGS

FIG. 1 is a flowchart illustrating a method of determining misfire in an engine of a vehicle according to an exemplary embodiment of the present disclosure.

FIG. 2 is a graph illustrating a method of controlling misfire in an engine of a vehicle according to an exemplary embodiment of the present disclosure.

FIG. 3 is a block diagram of a device for controlling misfire in an engine of a vehicle according to an exemplary embodiment of the present disclosure.

### DETAILED DESCRIPTION OF EXEMPLARY EMBODIMENTS

Exemplary embodiments of the present disclosure will now be described hereafter in detail with reference to the accompanying drawings.

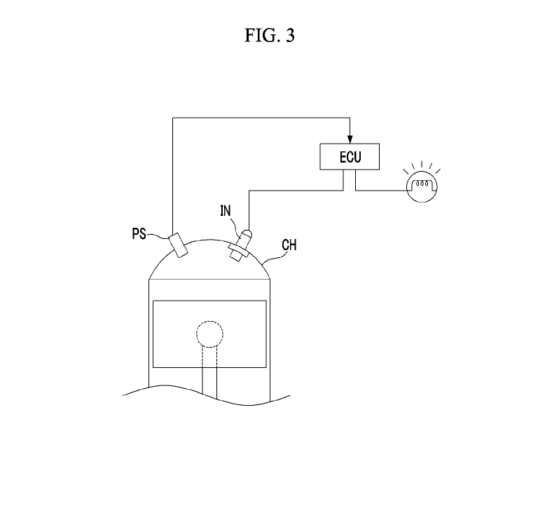

Referring to FIG. 3, a device for controlling misfire in an engine (e.g., of a vehicle) according to an exemplary embodiment of the present disclosure includes a combustion pressure detecting sensor that is disposed on a cylinder head defining a combustion chamber of an engine and senses combustion pressure in the combustion chamber. The combustion pressure detecting sensor may be disposed on a glow plug mounted on the cylinder head of the engine.

Further, an injector that injects fuel into the combustion chamber is included.

The injector is connected to an output terminal of an ECU (Electronic Control Unit), and the ECU controls the injection time of fuel to be injected into the combustion chamber from the injector.

The combustion pressure detecting sensor is connected to an input terminal of the ECU to notify the ECU of the combustion pressure in the combustion chamber.

The ECU determines whether there is a misfire in the combustion chamber by the following method.

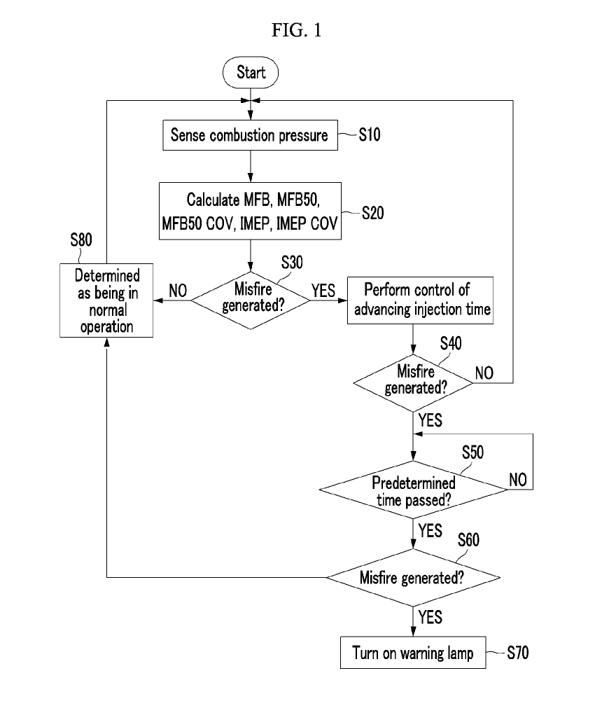

Referring to FIG. 1, the ECU is notified of the combustion pressure in the combustion chamber by receiving a sensing signal from the combustion pressure detecting sensor (S10).

The ECU then calculates the MFB, MFB50, MFB50 COV, IMEP, and

IMEP COV in accordance with pre-installed programs on the basis of the sensing signal (S20).

The MFB, Mass Fraction of Burning Rate, means a ratio of the amount of combustion heat at a specific point of time to the total amount of combustion heat.

The MFB50 means a point of time at which the amount of combustion heat is 50% of the total amount of combustion heat; i.e., the point of time of combustion when there is the most active combustion.

IMEP is an acronym for Indicated Mean Effective Pressure.

The COV, Coefficient of Variation, means a variation to the average and the degree of variation of a specific factor for a predetermined time.

Misfire in a combustion chamber is a phenomenon in which the IMEP is reduced or changed by instability of combustion due to combustion delay (delay of MFB50).

Misfire in a combustion chamber is usually generated when there is too much EGR (Exhaustion Gas Recirculation) or when the air/fuel ratio rapidly decreases due to a rapid acceleration of, e.g., a vehicle.

When misfire is generated in a combustion chamber, drivability of a vehicle is deteriorated. For example, a vehicle may rattle while traveling, an engine torque may decrease, noise and vibration may be generated, noxious components may be excessively contained in the exhaustion gas, and the fuel efficiency of a vehicle may decrease.

A desired MFB50 set in accordance with the number of revolutions of an engine and the engine load is mapped in advance in the ECU.

The ECU determines whether misfire is generated on the basis of the values calculated as described above (S30).

That is, the ECU determines that there is misfire, when determining that the calculated MFB50 has been delayed at 5 degrees or more in a crank angle, by comparing the calculated MFB50 with the desired MFB50 and determining whether the calculated MFB50 has been delayed at 5 degrees or more from the desired MFB50.

Further, the ECU determines whether the calculated MFB50 COV is 20% or more, and determines that there is misfire when determining that the calculated MFB50 COV is 20% or more.

Further, the ECU determines whether the calculated IMEP COV is 20% or more, and determines that there is misfire when determining that the calculated IMEP COV is 20% or more.

When it is determined that there is no misfire in S30, the engine is considered as operating in the normal state and the process returns to S10.

When it is determined that there is misfire in S30, the ECU advances the injection time by supplying a control signal to the injector (S40).

The ECU performs the following control such that the current MFB50 follows the desired MFB50.

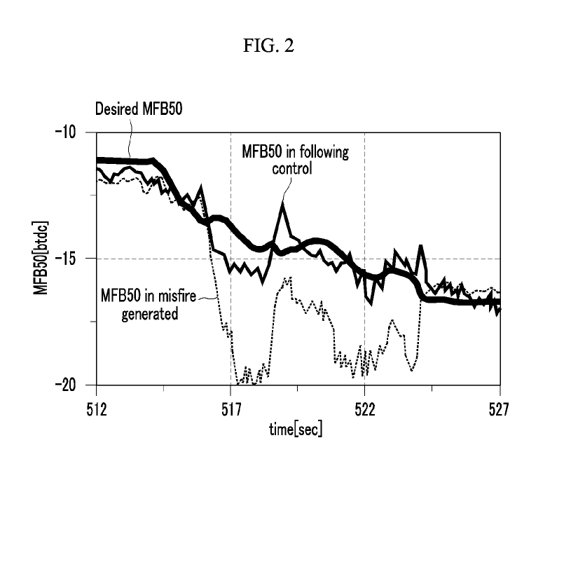

That is, as shown in FIG. 2, when there is misfire in a combustion chamber of an engine and the crank angle of the MFB50 is delayed, the fuel injection time is advanced to follow the desired MFB50.

Thereafter, the ECU determines again whether misfire has been generated (S40), and returns to the initial state when determining that misfire has been controlled without being generated, but determines whether a predetermined time has passed when misfire keeps progressing (S50).

For example, when misfire keeps progressing for five seconds or more, even though the ECU advances the fuel injection time (S60), a warning lamp is turned on to arouse the driver's attention (S70).

When misfire is removed after a predetermined time, the ECU determines that the engine is in normal operation (S80) and returns to the initial state.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

1. A method of determining misfire in an engine, comprising:
sensing combustion pressure in a combustion chamber of an engine while the engine is operated;
calculating MFB (a ratio of the amount of combustion heat at a specific point of time to the total amount of combustion heat), MFB50 (a point of time at which the amount of combustion heat is 50% of the total amount of combustion heat), MFB50 COV (Coefficient of Variation), IMEP (Indicated Mean Effective Pressure) and IMEP COV, from the combustion chamber;
setting a desired MFB50; and
determining that there is misfire when a crank angle is delayed at 5 degrees or more, the MFB50 COV is 20% or more, or the IMEP COV is 20% or more, by comparing the calculated MFB50 with the desired MFB50.

2. The method of claim 1, wherein the desired MFB50 is set in accordance with the number of revolutions of an engine and engine load.

3. A method of controlling misfire in an engine by advancing an injection time such that the MFB50 follows the desired MFB50, when it is determined that there is misfire in the engine by the method of determining misfire of claim 1.

4. The method of claim 3, further comprising:
determining whether a predetermined time has passed after the injection time is advanced, and
turning on a warning lamp when misfire keeps progressing even after the predetermined time passes.

5. The method of claim 4, wherein the predetermined time is five seconds or more.

6. A device for controlling misfire in an engine, comprising:
a combustion pressure detecting sensor that senses combustion pressure in an engine;
an injector that injects fuel into the engine; and
a control unit that controls the injector by performing the method of controlling misfire of claim 3.

7. The device of claim 6, further comprising:
a warning lamp,
wherein whether a predetermined time, after the injection time is advanced, has passed is determined, and
the warning lamp is turned on when the misfire keeps progressing even after the predetermined time passes.

8. The device of claim 7, wherein the predetermined time is five seconds or more.

9. A method of controlling misfire in an engine by advancing an injection time such that the MFB50 follows the desired MFB50, when it is determined that there is misfire in the engine by the method of determining misfire of claim 2.
